(19) United States
(12) Patent Application Publication
(10) Pub. No.: US 2004/0081218 A1
(43) Pub. Date: Apr. 29, 2004

(54) Gaseous optical systems for high energy laser beam control and anti-laser defense

(75) Inventors: Nelson Tabirian, Winter Park, FL (US); Sarik Nersisyan, Orlando, FL (US)

Correspondence Address: Dr. Nelson V. Tabirian, 686 Formosa Ave., Winter Park, FL, 32789, US

(73) Assignee: Beam Engineering for Advanced Measurement Co., Winter Park, FL

(21) Appl. No.: 10/280,547

(22) Filed: Oct. 25, 2002

(51) Int. Cl. H01S 3/22

(52) U.S. Cl. 372/58

(57) ABSTRACT

The objective of the present invention is providing a method and ultra light-weight instruments for controlling propagation of high energy laser beams. The control optical systems are based on gases and techniques for creating gas concentration and flow patterns that modulate the refractive index along the path of propagation of a laser beam.

### STATEMENT REGARDING FEDERALLY SPONSORED RESEARCH OR DEVELOPMENT

This invention was made with Government support under SBIR Contracts No. DASG60-01-C-0034.

### RIGHTS OF THE GOVERNMENT

The invention described herein may be manufactured and used by or for the Government of the United States for all governmental purposes without the payment of any royalty.

### CROSS-REFERENCES

[1] A. B. Bhatia, Ultrasonic absorption, Dover Publications, New York, 1985

[2] O. Peterson, Entwicklung einer optischen Methode zur Messung von Ultraschallabsorptionen in Gasen und Flussigkeiten, Physikalische Zeitschrift, 41 (2), 29-41, 1940.

[3] H. J. Eichler, Laser-Induced Dynamic Gratings, Springer Series in Optical Sciences, Vol 50, 1986.

U.S. PATENT DOCUMENTS

| | | |
|---|---|---|
| 5,741,442 | April 1998 | McBranch, et al. |
| 5,589,101 | December 1996 | Khoo |
| 6,470,107 | October 2002 | Brockett, et al. |
| 6,459,720 | October 2002 | Kleinschmidt, et al. |
| 6,442,181 | August 2002 | Oliver, et al. |

### BACKGROUND OF THE INVENTION

High-energy lasers are found presently not only in defense related facilities, but in industry and research laboratories as well. Latest developments are directed towards realization of airborne and space stationed lasers to be mounted on aircrafts and platforms in space. These lasers have critically important role for future missile defense systems. The optics for directing, collimating and focusing of those high power laser beams is based on metal mirrors, which are typically cooled by water flows. Large sizes of such optical elements, comparable to the large sizes of the laser beams to be controlled, make those elements very heavy driving the cost of their deployment rather high. The stands, holders, and actuators for such optics further increase the weight, energy consumption, and the cost of deployment and operation of high power laser systems. Another disadvantage of the present-day optical elements for controlling high power laser beams consists in deterioration of their quality due to laser induced damages and the resultant deterioration of the laser beam quality.

On the other hand, high power lasers can be used for counter measures, and it is critically important to harden the satellites, space platforms, and ballistic missiles against such beams. Presently, there exist no technology for defending these and other strategically important objects against high energy laser radiation. There has been significant advances, however, in protection of optical sensors and cameras against laser induced damage or jamming as discussed, particularly, in the U.S. Pat. No. 5,741,442 to McBranch et al. and in the U.S. Pat. No. 5,589,101 to Khoo.

The laser power level capable of inducing permanent damage to optical sensors is many orders of magnitude smaller than that required for destroying a missile or drilling a hole in a sheet of metal. Consequently, the techniques for sensor protection cannot be used or adapted for anti-laser defense.

In search for high damage threshold, light-weight, and inexpensive materials for high power laser optics, let us note that air is the most natural optical material interfacing conventional glass or liquid optical elements. Air is substituted by other gases in certain situations like the one described in the U.S. Pat. No. 6,470,107 to Brockett, et al. One of the most important uses of gases as optical materials is in gas lasers such as He-Ne, CO2 and eximer where gases are the gain materials as described, for example, in U.S. Pat. No. 6,459,720 to Kleinschmidt, et al., and in U.S. Pat. No. 6,442,181 to Oliver, et al. Interfaces between different gases were not previously considered for making optical components for at least two reasons: first, due to the impossibility of creating sharp boundaries of the order of the wavelength of optical radiation, and, second, due to the smallness of the variations of refractive indices of gases from that of vacuum.

Modulation of the refractive index of gases due to generation of ultrasound waves is a straightforward mechanism of creating a gaseous optical element—a diffraction grating for laser beams. However, the efficiency of such gratings is extremely low, of the order of 10⁻⁵, due to the smallness of the pressure modulation in the ultrasound waves. Therefore, the diffraction of laser beams on ultrasound gratings generated in gases have been used only for the study of the gas properties as described in references [1] and [2].

### BRIEF SUMMARY OF THE INVENTION

The first objective of the present invention is to provide means for design and construction of ultra-lightweight, inexpensive and regenerative optical components for controlling the propagation of high power laser beams.

The second objective of this invention is to provide means for anti-laser defense for missiles, satellites and other material objects.

The invention includes generating gas micro-jet patterns in vacuum or in a mixture of gases using techniques that allow controlling the spatial distribution of the refractive index of a gaseous medium along the propagation path of the laser beam.

Further objectives and advantages of this invention will be apparent from the following detailed description of presently preferred embodiment, which is illustrated schematically in the accompanying drawings.

### BRIEF DESCRIPTION OF THE SEVERAL VIEWS OF THE DRAWING

FIG. 1 shows an embodiment of the apparatus for generation of gaseous optical gratings—periodically distributed planar gas micro-jets.

FIG. 2 shows a prototype embodiment of a gas flow patterning assembly made of metal blades.

FIG. 3 shows a prototype apparatus for generation of gaseous optical gratings.

FIG. 4 shows an embodiment of the arrangement of the gaseous optical grating with respect to the laser beam in order of obtaining and observing diffractive changes in the propagation of the beam.

FIG. 5 shows the profile of a laser beam with no gas flow.

FIG. 6 shows the symmetric diffraction patterns of the laser beam due to the gaseous optical grating.

FIG. 7 shows the asymmetric diffraction patterns of the laser beam due to the gaseous optical grating.

FIG. 8 shows spherical lens action of a gas-optical transducer resulting in changes in the laser beam size.

FIG. 9 shows cylindrical lens action of a gas-optical transducer resulting in changes of the laser beam size in horizontal or vertical directions.

FIG. 10 shows transformation of the Gaussian distribution of a laser beam power into a conical profile by gas-optical transducer.

FIG. 11 shows the result of attenuation of the laser beam power on the target plane due to engagement of a gas-optical transducer.

FIG. 12 shows the beam steering action of a gas-optical transducer in vertical direction.

FIG. 13 shows the beam steering action of a gas-optical transducer in horizontal direction.

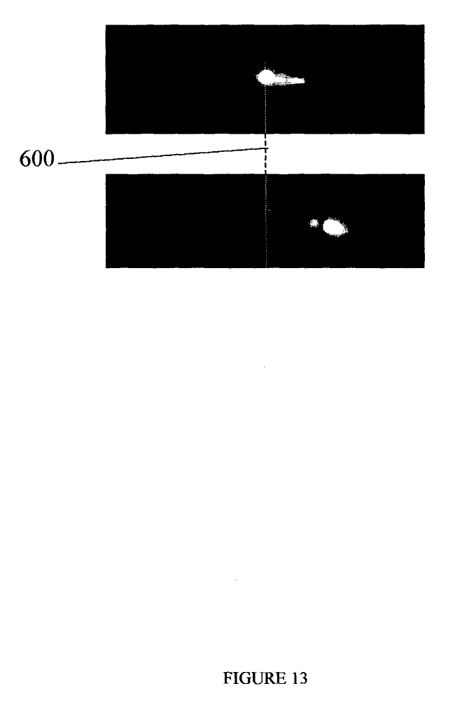

### DETAILED DESCRIPTION OF THE INVENTION

Before explaining the disclosed embodiment of the present invention in detail it is to be understood that the invention is not limited in its application to the details of the particular arrangement shown since the invention is capable of other embodiments. Also, the terminology used herein is for the purpose of description and not limitation.

The following evaluation makes the basis for proving the feasibility of the gas-optical transducers (GOT) that create gaseous optical elements for controlling of laser beams. The diffraction of efficiency of optical gratings created by spatially modulating the refractive index of a material is given by the formula

$$η = {[ \frac{π L δ n}{λ} ]}^{2}$$

where L is the thickness of the material the refractive index of which is modulated by δn, and λ is the wavelength of the laser radiation [3]. As evident from the Table 1, which demonstrates the values of the difference between the refractive indices of different gases (all the values are approximate and are taken from different resources), the refractive index modulation can reach values of the order of 10⁻⁴ for interchanging layers made of different gases. The diffracted intensity can reach values comparable to the intensity of the main beam at the values of its argument of the order of (2πL/λ)δn˜1. Thus, the diffraction efficiency for an optical radiation of the wavelength λ=1 μm is becoming rather large already for few millimeter thickness of the material.

TABLE 1
The difference in the refractive indices of various gases

| | | | Carbon | | | | |
|---|---|---|---|---|---|---|---|
| | Air | Helium | Dioxide | Argon | Xenon | SF6 | Vacuum |
| Air | 0.00E+00 | 2.57E−04 | −1.56E−04 | 1.20E−05 | −4.09E−04 | −4.90E−04 | 2.93E−04 |
| Helium | −2.57E−04 | 0.00E+00 | −4.13E−04 | −2.45E−04 | −6.66E−04 | −7.47E−04 | 3.60E−05 |
| Carbon Dioxide | 1.56E−04 | 4.13E−04 | 0.00E+00 | 1.68E−04 | −2.53E−04 | −3.34E−04 | 4.49E−04 |
| Argon | −1.20E−05 | 2.45E−04 | −1.68E−04 | 0.00E+00 | −4.21E−04 | −5.02E−04 | 2.81E−04 |
| Xenon | 4.09E−04 | 6.66E−04 | 2.53E−04 | 4.21E−04 | 0.00E+00 | −8.10E−05 | 7.02E−04 |
| SF6 | 4.90E−04 | 7.47E−04 | 3.34E−04 | 5.02E−04 | 8.10E−05 | 0.00E+00 | 7.83E−04 |
| Vacuum | −2.93E−04 | −3.60E−05 | −4.49E−04 | −2.81E−04 | −7.02E−04 | −7.83E−04 | 0.00E+00 |

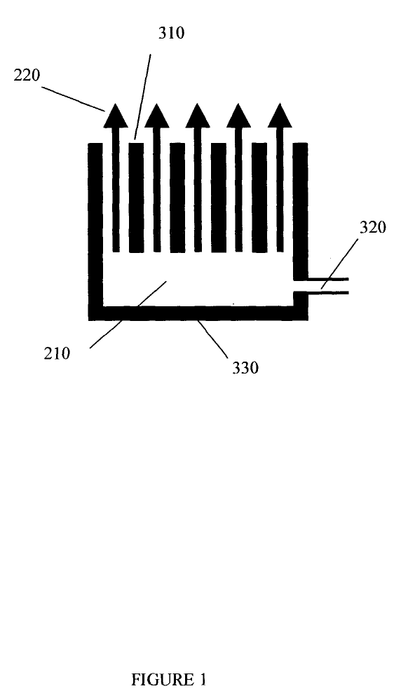

GOT consist in three essential components: a source of a pressurized gas such as Helium; a mechanism for delivering the gas at a predetermined pressure to a gas chamber; and the gas flow patterning assembly (GFPA), which is fixed in the gas chamber. Referring to the drawing of the preferred embodiment shown in FIG. 1, the GFPA consists of a number of thin plates 310 arranged at a predetermined distance from each other. The plates can be made of metallic blades as well as of other materials the thin sheets of which posses structural rigidity sufficient to ensure undistorted flow of the gas 220 in-between the plates.

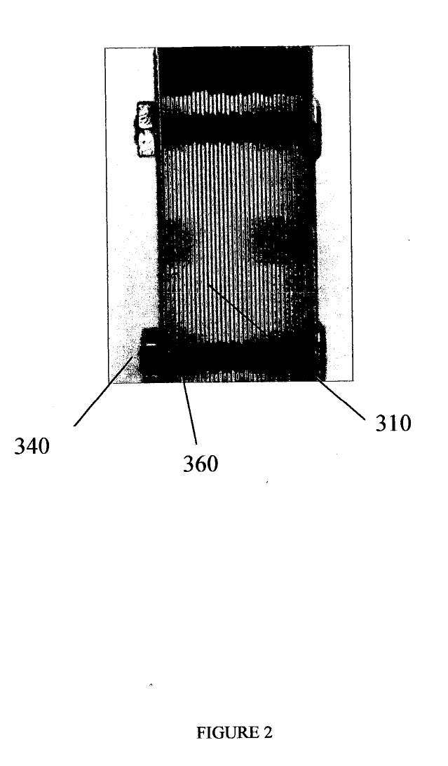

The plate assembly is fixed in a gas chamber 330, which has a plenum 210 and an opening for the gas input 320. Blowing a Helium gas through such a gas flow patterning head creates interchanging layers of Helium, which evolves into a mixture of gases with modulated refractive index, which may act as a diffraction grating. In the prototype realization shown in FIG. 2, the GFPA is made of metallic blades 310 separated with Teflon spacers 360 and kept together with screws 340.

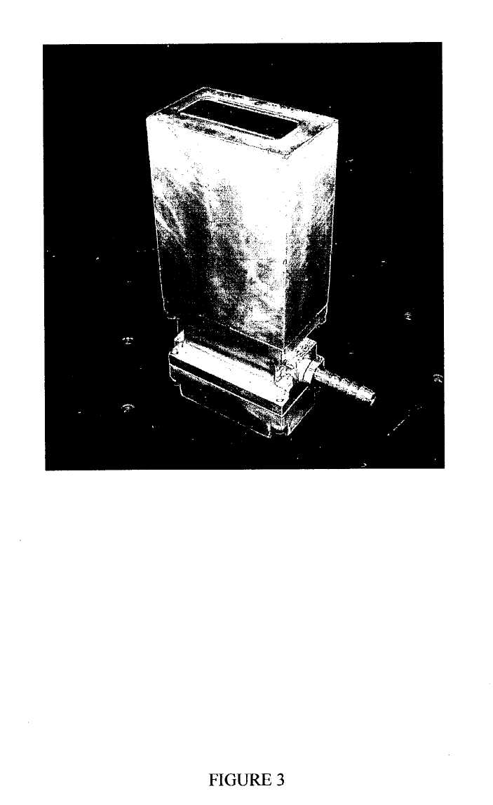

The gas 200 is delivered to the FPA 300 at a controlled pressure as shown in FIG. 3. The output of the FPA is directed towards the laser beam 100 the propagation of which needs to be controlled. In the proof-of principle tests, a CCD 400 was used to image the laser beam traversed through the region of engagement of the GOT, and the changes in the beam profile were monitored with a display 500.

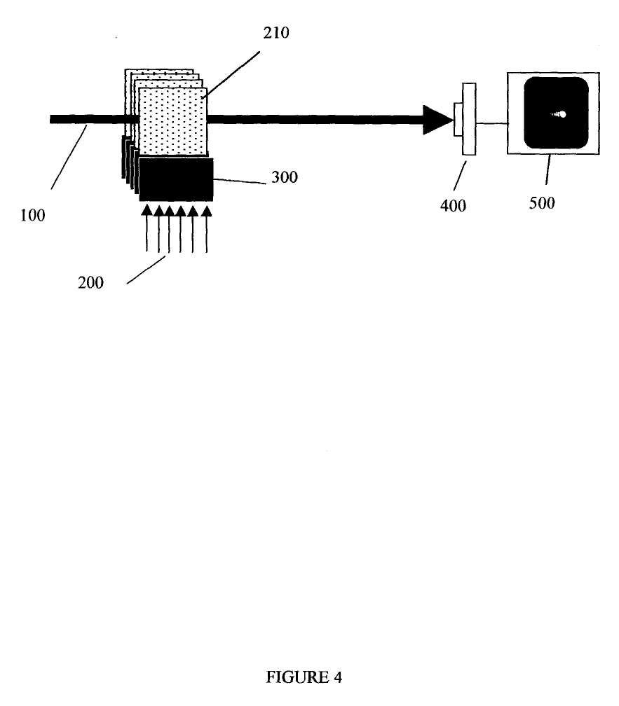

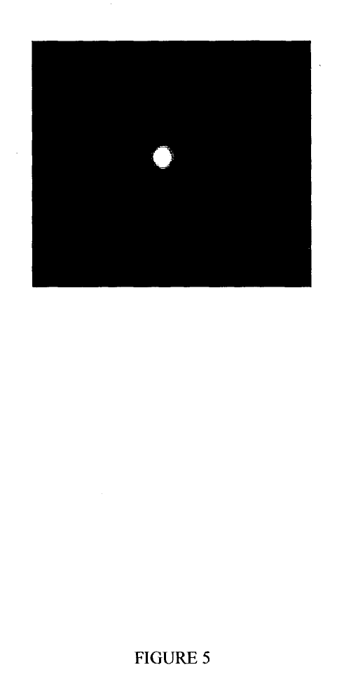

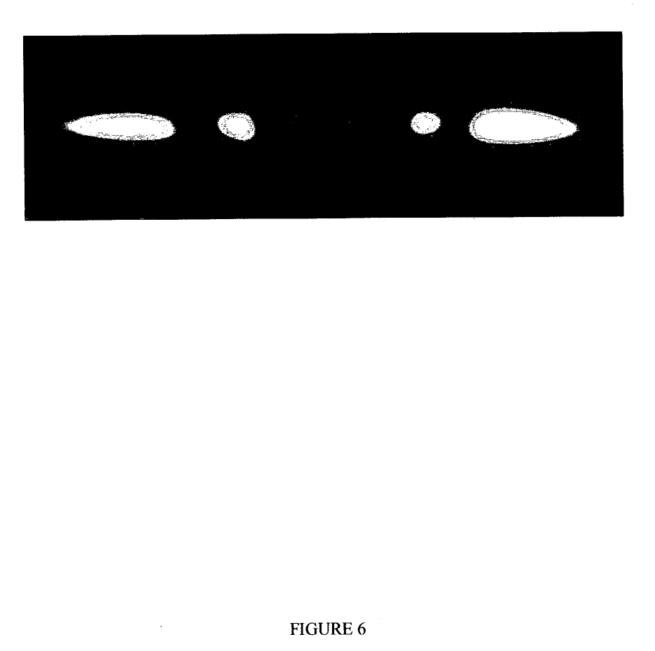

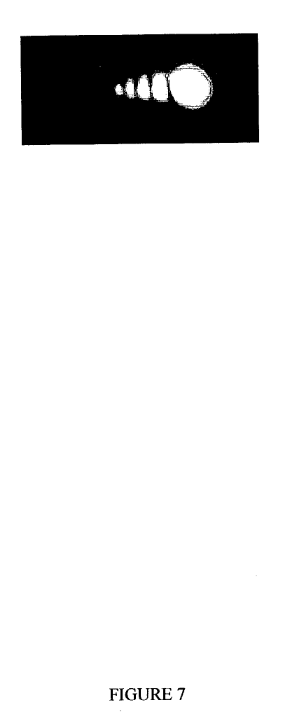

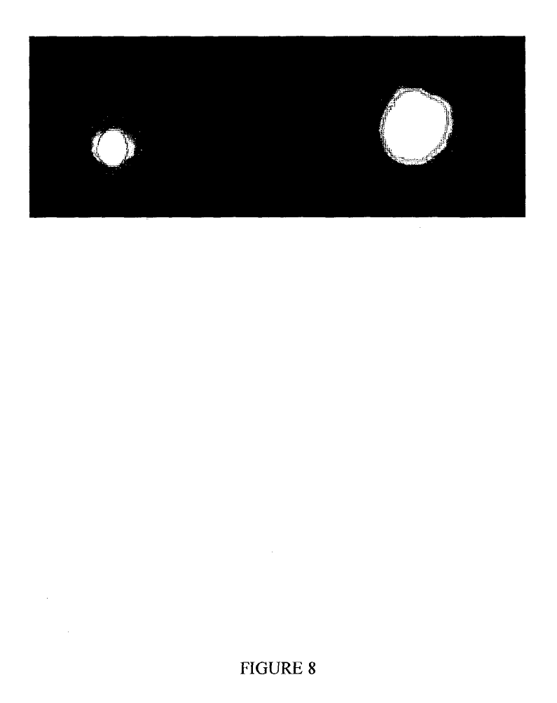

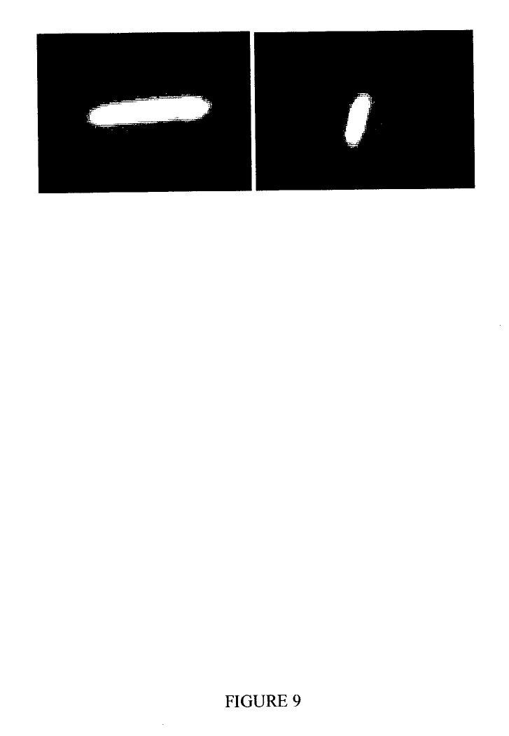

Choosing the rate of flow, the pressure gradients, the size and the pattern of the gas flow, GOT of wide range of functions can be realized. Prototype GOT allowed to realize diffraction of a laser beam transforming the Gaussian profile of the beam shown in FIG. 4 into the diffraction patterns shown in FIG. 5. More complex transformations of the beam have been realized by us. FIG. 6 present examples of asymmetric diffraction. FIG. 7 shows modeling of the action of a spherical lens leading to changes in the size of the beam. FIG. 8 shows modeling of cylindrical lens action by a GOT changing the size of the beam either in horizontal or in vertical directions. FIG. 9 shows redistribution of a Gaussian laser beam power into an elliptical ring.

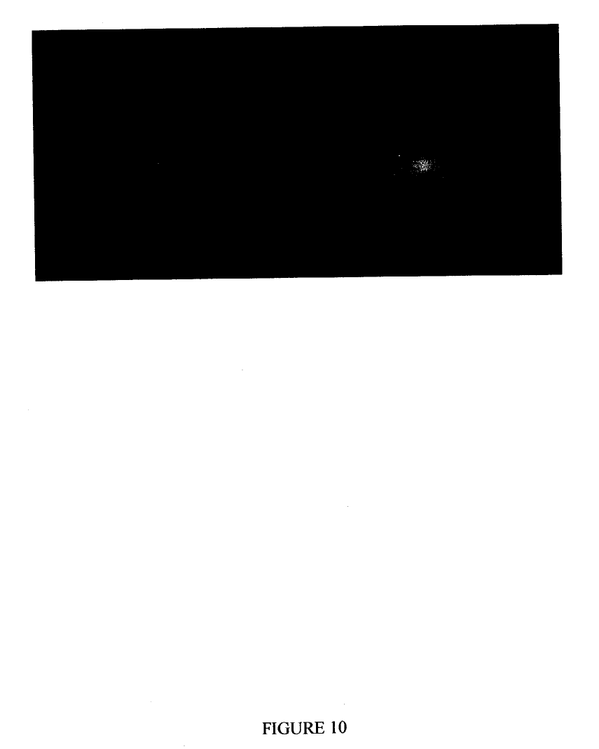

Effective redistribution of the laser beam energy obtained with the aid of gaseous optical gratings and lenses allows reducing the energy density level of the laser beam at the target plane. Thus, gaseous optical shields can be designed for protection against high power laser beams. Examples of modeling of such an anti-laser defense optical shields are shown in FIG. 10.

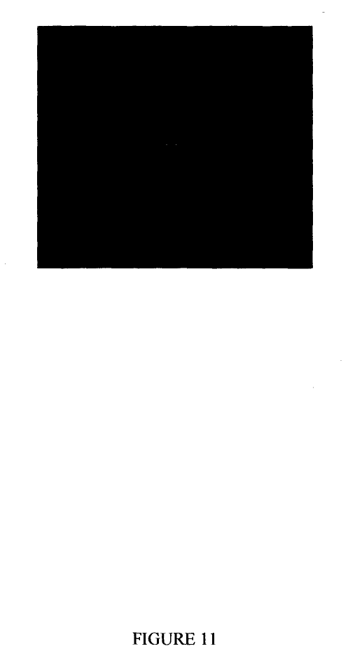

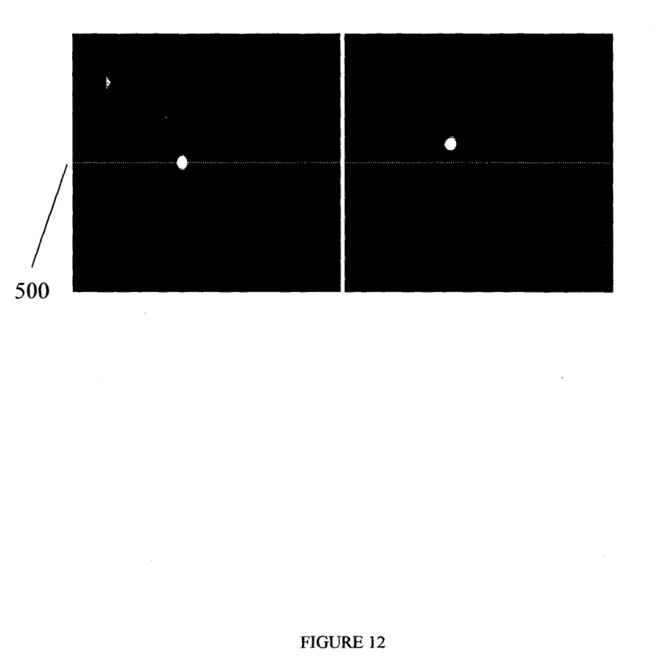

GFPA modelling a prism action makes possible steering of the laser beam as shown in FIG. 11 and FIG. 12, where the dashed lines 500 and 600 show the original position of the beam along horizotal and vertical axes, respectively.

Gaseous optics is a breakthrough in laser beam control techniques due to its ultra light-weight, variable functionality, switchability, and simplicity. It can inexpensively be incorporated into high energy laser systems from one hand, and can underly anti-laser defense systems from the other hand.

The gaseous optics and the method underlying it, in accordance with the present invention, offers, among others, the following advantages:

There are no practical limitations to the damage threshold of these optical systems;

Large area ultra light-weight optical elements can be constructed;

The technique can operate for laser beams in a wide spectrum of wavelengths;

The devices can easily and inexpensively be manufactured;

These optical systems can be switched on and off.

Variety of operation features can be obtained in the framework of the same system.

These optical systems are self-regenerative.

What is claimed is:

1. An apparatus for controlling the propagation of a laser beam comprising:
a. a source of a pressurized gas or a mixture of gases;
b. means for delivering, directing and aligning the flow of said gas into the propagation path of said laser beam;
c. means for spatially modulating the refractive index distribution of said gaseous medium;
d. means for controlling the flow rate and pattern of said gas.

2. An apparatus for spatially modulating the refractive index distribution of a gaseous medium comprising:
a. thin plane material layers;
b. thin spacers separating said material layers and creating micro-channels allowing gas flow;
c. means for holding said micro-channels together;
d. a chamber for directing the gas flow through the said micro-channels at a predetermined pressure.

3. An apparatus as in claim 2 wherein the thin plane layers are metal blades.

4. An apparatus as in claim 2 or 3 wherein the thin layers are folded to have non-planar geometry such as cylinders.

5. An apparatus for spatially modulating the refractive index distribution of a gaseous medium comprising:
a. a block of a solid material such as metal, ceramic, plastic, but not limited to those;
b. micro-channels of a predetermined geometry obtained in said block of the material by machining, molding, lithography, or by other means;
c. a chamber for directing the gas flow through said micro-channels at a predetermined pressure.

6. An apparatus for spatially modulating the refractive index distribution of a gaseous medium comprising:
a. a cylinder containing input and output windows for propagation of a laser beam through the cylinder;
b. a gas or a mixture of gases filling said cylinder at a predetermined pressure;
c. means for rotating said cylinder around its axis;
d. means for controlling the angular speed of rotation of said cylinder.

7. An apparatus for controlling propagation properties of a laser beam comprising:
a. more than one means for modulating the refractive index distribution of a gaseous medium as in claims 2 to 6;
b. means for combining said gas flows in the path of said laser beam.

8. A method for controlling the propagation of a laser beam comprising:
e. a source of a pressurized gas or a mixture of gases;
f. means for delivering, directing and aligning the flow of said gas into the propagation path of said laser beam;
g. means for spatially modulating the refractive index distribution of said gaseous medium;
h. means for controlling the flow rate and pattern of said gas.

9. A method for spatially modulating the refractive index distribution of a gaseous medium comprising:
e. thin plane material layers;
f. thin spacers separating said material layers and creating micro-channels allowing gas flow;
g. means for holding said micro-channels together;
h. a chamber for directing the gas flow through the said micro-channels at a predetermined pressure.

10. A method as in claim 9 wherein the thin plane layers are metal blades.

11. A method as in claim 9 or 10 wherein the thin layers are folded to have non-planar geometry such as cylinders.

12. A method for spatially modulating the refractive index distribution of a gaseous medium comprising:
d. a block of a solid material such as metal, ceramic, plastic, but not limited to those;
e. micro-channels of a predetermined geometry obtained in said block of the material by machining, molding, lithography, or by other means;
f. a chamber for directing the gas flow through said micro-channels at a predetermined pressure.

13. A method for spatially modulating the refractive index distribution of a gaseous medium comprising:
e. a cylinder containing input and output windows for propagation of a laser beam through the cylinder;
f. a gas or a mixture of gases filling said cylinder at a predetermined pressure;
g. means for rotating said cylinder around its axis;
h. means for controlling the angular speed of rotation of said cylinder.

14. A method for controlling propagation properties of a laser beam comprising:
c. more than one means for modulating the refractive index distribution of a gaseous medium as in claims 9 to 13;
d. means for combining said gas flows in the path of said laser beam.
